(19) United States
(12) Patent Application Publication
(10) Pub. No.: US 2015/0244861 A1
(43) Pub. Date: Aug. 27, 2015

(54) INTERNATIONAL DIALING THROUGH CALL CONNECTIONS

(71) Applicant: Talk.to FZC, Ras Al Khaimah (AE)

(72) Inventor: Bhavin Turakhia, Mumbai (IN)

(21) Appl. No.: 14/341,664

(22) Filed: Jul. 25, 2014

Related U.S. Application Data
(63) Continuation-in-part of application No. 14/296,112, filed on Jun. 4, 2014.

(30) Foreign Application Priority Data
Feb. 27, 2014 (IN) 696/MUM/2014
Jun. 5, 2014 (IN) 1856/MUM/2014

(51) Int. Cl. H04M 3/42; H04M 7/12; H04W 8/26

(52) U.S. Cl. CPC H04M 3/42306; H04W 8/26; H04M 7/1275

(57) ABSTRACT

In example embodiments, a system and method for international dialing through call connections is provided. An indication of an initiation of a call by a first user to a second user is received. A notification call is made to the second user in response to receiving the indication of the initiation of the call. The notification call provides a second pool number to the second user that is different from a phone number of the first user. A first call is received at any time from the first user, and a second call is received via the second pool number from the second user. The first call and the second call are connected.

### CROSS REFERENCE TO RELATED APPLICATIONS

The present application claims the priority benefit under 35 U.S.C. §119 of Indian Patent Application No. 1856/MUM/2014 (Attorney Docket No. 3761.0161N2), filed on Jun. 5, 2014, and also is a continuation-in-part of, and claims the priority benefit of, U.S. patent application Ser. No. 14/296,112 (Attorney Docket No. 3761.016US1), filed on Jun. 4, 2014, which in turn claims the priority benefit under 35 U.S.C. §119 of Indian Patent Application No. 696/MUM/2014 (Attorney Docket No. 3761.016IN1), filed on Feb. 27, 2014, all of which are incorporated herein by reference in their entirety.

### FIELD

The present disclosure relates generally to communications, and in a specific example embodiment, to providing dialing through call connections.

### BACKGROUND

When a user wants to call an individual internationally using their mobile device, the user dials the international phone number of the individual. The cost for the call to the individual will typically cost more than a domestic or local call for the user. While some systems allow for cheaper calls using Voice-over-IP (VoIP), VoIP is typically available only where the mobile device has a good Internet connection. Additionally, the call quality of a VoIP call may be sometimes problematic.

### BRIEF DESCRIPTION OF DRAWINGS

Various ones of the appended drawings merely illustrate example embodiments of the present invention and cannot be considered as limiting its scope.

FIG. 1 is a diagram illustrating an environment in which example embodiments of a system for dialing through call connections may be implemented.

FIG. 2 is a block diagram illustrating an example embodiment of a user device.

FIG. 3 is a block diagram illustrating an example embodiment of a service provider system.

FIG. 4A is a communication flow diagram for international dialing through call connections according to one example embodiment.

FIG. 4B is a communication flow diagram for international dialing through call connections according to another example embodiment.

FIG. 4C is a communication flow diagram for international dialing through call connections according to another alternative example embodiment.

FIG. 4D is a communication flow diagram for international dialing through call connections according to further alternative example embodiment.

FIG. 5 is a flow diagram of an example method for providing international dialing through call connections.

FIG. 6 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for providing dialing (e.g., long distance dialing or international dialing) through call connections. According to some embodiments, an indication of an initiation of a call by a first user to a second user is received by a server of a service provider system. In response to receiving the indication, a notification call is made to the second user by the service provider system. The notification call may provide a second pool number to the second user that is different from a phone number of the first user, instruct the second user to call the second pool number to be connected with the first user, or both. A first call is received at any time from the first user (e.g., before, during, or after the notification call). In example embodiments, the first call is to a first pool provided to the first user, and the first pool number may be different from a phone number of the second user number. Additionally, a second call is received via the second pool number from the second user. The first call and the second call are then connected. As a result, a potentially expensive international call may be converted into two relatively inexpensive local calls (e.g., local to each respective user).

In some embodiments, a communication application may be provided on the user device of the first user. The communication application can provide functionalities or advantages over a native calling application on the user device. For example, the use of the communication application may allow for a lower rate or lower cost on international communications (e.g., calls, text messages, or chat messages) such that, for example, whenever the user tries to initiate an international call, the communication application may request, obtain, and use a pool number for local calling (e.g., in a local calling area relative to the user). The pool number may comprise a low cost alternative relative to directly calling the long distance number since the local number may be in a same area code as the user (e.g., is a domestic low or no cost number).

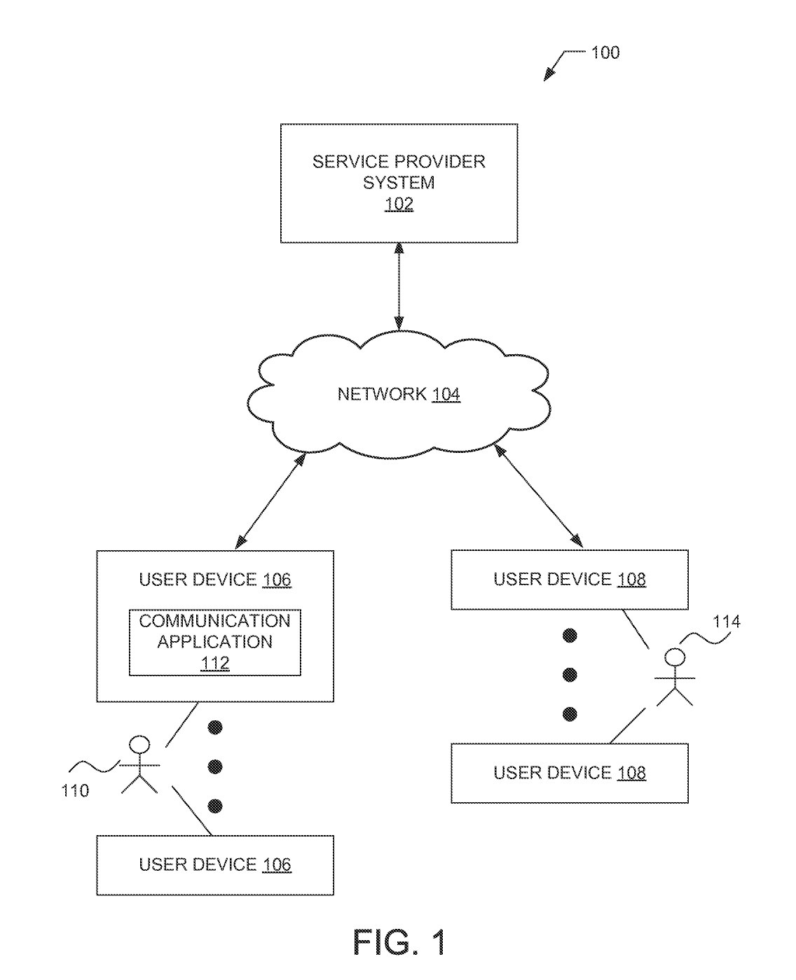

With reference to FIG. 1, a diagram illustrating an example network environment 100 in which example embodiments of a system for international dialing through call connection is provided. The network environment 100 comprises a service provider system 102 coupled via a network 104 to one or more first user devices 106 and to one or more second user devices 108. The network 104 may be any network that enables communication between or among machines, databases, and devices (e.g., the first user device 106, the second user device 108, and the service provider system 102). Accordingly, the network 104 may be a wired network, a wireless network (e.g., a mobile or cellular network), or any suitable combination thereof. The network 104 may include one or more portions that constitute a private network, a public network (e.g., the Internet), or any suitable combination thereof. Accordingly, the network 104 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMAX network), or any suitable combination thereof. Any one or more portions of the network 104 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

The first user devices 106 are associated with a first user 110 who is attempting to place an international or long distance call. The first user 110 may be a human user (e.g., a human being), a machine user (e.g., a computer configured by a software program to interact with the first user device 106), or any suitable combination thereof (e.g., a human assisted by a machine or a machine supervised by a human). The first user 110 is not part of the network environment 100, but is associated with the first user devices 106 and may be a user of one or more of the first user devices 106. For example, the first user device 106 may be a smartphone, a telephone, a desktop computer, a vehicle computer, a tablet computer, a portable media device, a smartphone, a wearable device (e.g., a smart watch or smart glasses), or any other device capable of making a call.

In example embodiments, the first user 110 may install a communication application 112 on one or more of the first user devices 106. The communication application 112 comprise pieces of functionality on the first user device 106 that provide functions or operations that allow the first user 110 of the first user device 106 to conduct an international call using call connections provided by the service provider system 102, as will be discussed in more detail below. The first user device 106 may also have a native calling application for providing communication services. Thus, the first user device 106 may comprise multiple applications for use in initiating a communication, and the first user 110 has an option to use any of the applications. It is noted that in some embodiments, the use or presence of the communication application 112 is not necessary for example operations to be performed as will be discussed in more detail below.

The one or more second user devices 108 are associated with a second user 114 that may be a call recipient of the first user 110. The second user 114 is not part of the network environment 100, but is associated with the second user devices 108 and may be a user of one or more of the second user devices 108. For example, the second user device 106 may be a smartphone, a telephone, a desktop computer, a vehicle computer, a tablet computer, a portable media device, a smartphone, a wearable device (e.g., a smart watch or smart glasses), or any other device capable of making and receiving a call.

In example embodiments, the second user devices 108 do not require installation of a communication application similar to the communication application 112 installed on the first user device 106. However, in some cases, the second user 114 may download or otherwise install the communication application onto one or more of the second user devices 108 that communicates with the service provider system 102 if they desire. Additionally, the second user device 108 may also have a native calling application for providing communication services. Thus, the second user device 108 may comprise multiple applications for use in initiating and receiving a communication.

In some embodiments, the service provider system 102 may provide the communication application 112 to the first user device 106 and possibly to the second user device 108 (e.g., provide a downloadable version of the service application, electronically send the service application to the user device 106, or physically send to the user via a storage medium such as a CD ROM). Some embodiments may be practiced without the use of the communication application 112 on (e.g., being stored by, or being executed by) the first user device 106 or any communication application on the second user device 108.

It is noted that the network environment 100 shown in FIG. 1 is merely an example. For instance, alternative embodiments may comprise any number of user devices 106 and 108 in the network environment 100 and any number of service provider systems 102.

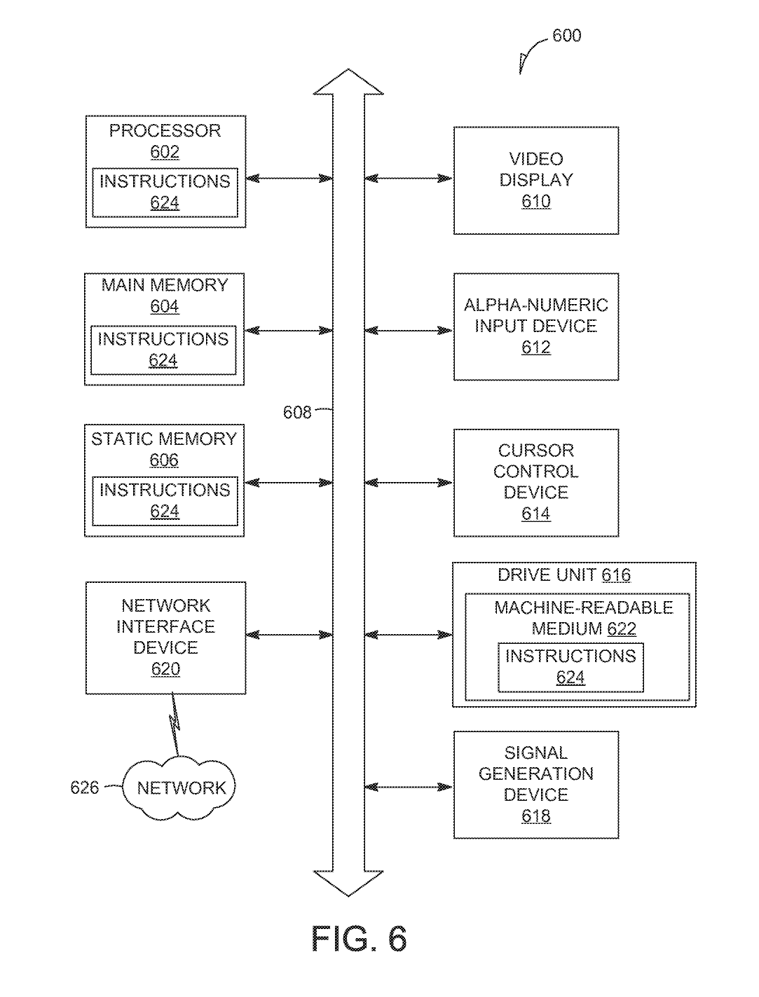

Any of the machines or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 6. Moreover, any two or more of the machines or devices illustrated in FIG. 1 may be combined into a single machine, and the functions described herein for any single machine or device may be subdivided among multiple machines or devices.

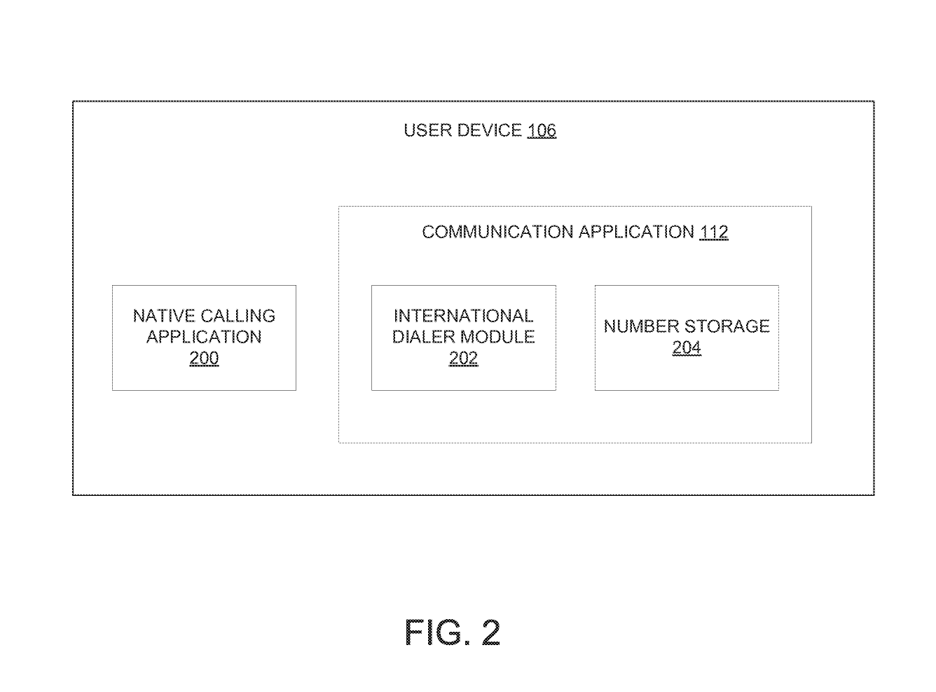

Referring now to FIG. 2, a block diagram illustrating an example embodiment of the first user device 106 is shown. The first user device 106 is illustrated as having the communication application 112 installed thereon. The first user device 106 may also include a native calling application 200. In some embodiments the communication application 112 and the native calling application 200 may be one and the same. The communication application 112 may provide enhanced communication functionality and services to the first user device 106. The communication application 112 may also initiate an international call to the service provider system 102. Accordingly, the communication application 112 may comprise an international dialer module 202 and a number storage 204. It is noted that the first user device 106 and the communication application 112 may comprise other modules not pertinent to example embodiments that are not shown or discussed.

The international dialer module 202 manages communications initiated by the user device 106 that are directed to international calling. Upon activation of the communication application 112, the international dialer module 202 allows the first user 110 of the first user device 106 to dial an international number of a callee (e.g., the second user 114) or select the international number for the callee from stored contact information (e.g., from the number storage 204). Once the international number is entered and a call initiated (e.g., selecting a “dial” or “talk” button) from within the communication application 112, the international dial module 202 may send a call indication to the service provider system 102 (e.g., via the Internet). In some embodiments, a (local) first pool number may be returned by the service provider system 102 in response to the call indication. Alternatively, if the first pool number has been previously assigned to the first user device 106 for the selected international number, the international dialer module 202 may take the selected international number and check for the local pool number in the number storage 204. In yet a further embodiment, if the user attempts to dial the international number using the native call application 200, the communication application 112 may intercept the call attempt and the international dialer module 202 may send the call indication to the service provider system 102, or may perform a lookup in the number storage 204 for a previously stored first pool number that corresponds to the dialed international number.

In some embodiments, the first pool number may be received at any or all of the first user devices 106. For example, the first user device 106 having the communication application 112 may send the call indication to the service provider system 102. However, the service provider system 102 may return the first pool number to all first user devices 106 that are registered for the first user 110 at the service provider system 102. Furthermore, a call to the first pool number (e.g., a first call) may be made from any of the first user devices 106 and not necessarily the first user device 106 having the communication application 112. Additionally, the first pool number may be received via one type of network (e.g., cellular network) and the call to the first pool number may be made using a different type of network (e.g., public switched telephone network (PSTN)).

In other embodiments, the first call may be an IP call made by the first user device 106 to the service provider system 102. The IP call or data sent along with the IP call may indicate one or more attributes or call parameters that the service provider system 102 may use to determine the second user 114. In these embodiments, the first pool number may not be necessary.

In some embodiments, the second user device 108 may be similar to the first user device 106. Alternatively the second user device 108 may not comprise a communication application. In some of these embodiments, the second user devices 108 may receive a notification message via short message service (SMS) or audio messaging (e.g., an automated call from the service provider system 102). The notification message may instruct the second user to call (e.g., using the native call application on the user device 108) a second pool number that is being provided with the notification message. Additionally, even if the second user device 108 comprises a communication application, the message may still be sent via SMS or via audio messaging. The second user 114 may receive the second pool number on one of the second user devices 108 and call the second pool number using a different one of the second user devices 108. Additionally, the second pool number may be received via one type of network (e.g., cellular network) and the call to the second pool number may be made using a different type of network (e.g., PSTN).

In an alternative embodiment, one or more of the second user devices 108 may comprise a similar communication application (e.g., similar to the communication application 112) as that of the first user device 106. The communication application at the second user device 108 may receive the notification message to call the second pool number (e.g., local number that is local to the second user) in response to the call initiated by the first user 110. The communication application may, in some embodiments, automatically dial the second pool number in response to receiving the notification message.

While example embodiments are discussed with respect to international calls, alternative embodiments may be directed to other forms of calls. For example, the call may be a long distance call within the same country.

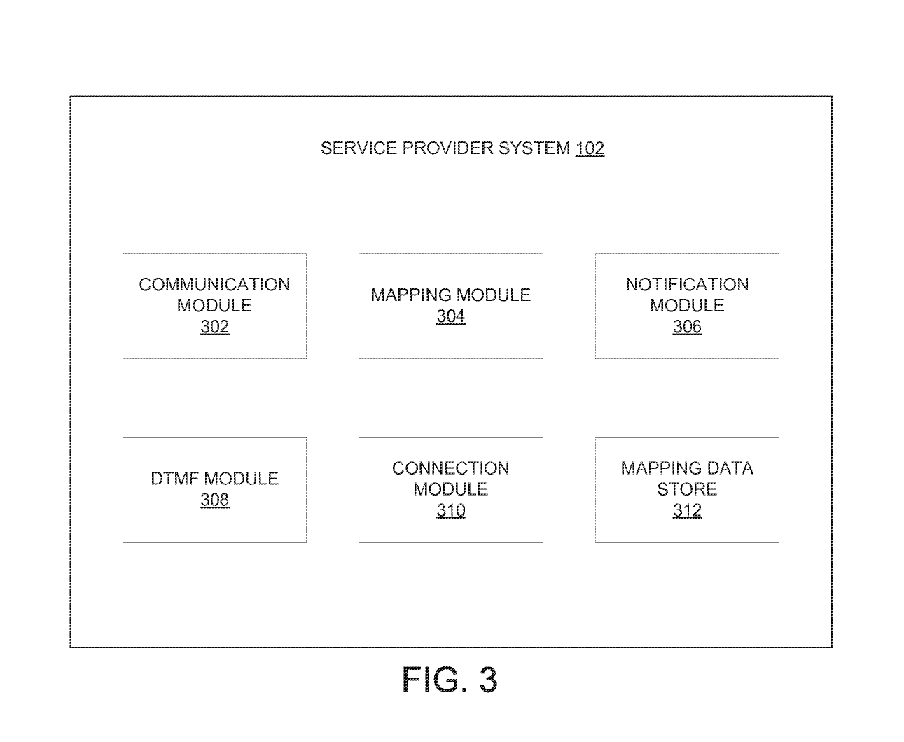

Referring now to FIG. 3, the service provider system 102 is shown in more detail. In example embodiments, the service provider system 102 may comprise one or more servers that provide communication functionalities and services including international dialing through call connections to users both having and not having the communication application 112 installed on their user devices. To enable these functionalities and services, the service provider system 102 may comprise a communication module 302, mapping module 304, a notification module 306, a dual-tone multi-frequency (DTMF) module 308, a connection module 310, and a mapping data store 312 coupled in communication with each other. The service provider system 102 may comprise other components not pertinent to example embodiments that are not shown or discussed. Furthermore, alternative embodiments may comprise more, less, multiples of, or other modules for providing international dialing through call connections. Additionally, some functions of the modules may be combined or divided into two or more further modules.

The communication module 302 manages receipt of calls and indications of initiation of calls from various user devices. In example embodiments, the communication module 302 receives an indication of initiation of a call from the first user to the second user. In some instances, the indication may indicate that the first user is attempting to call the second user using the international number for the second user and may include a request for a pool number that is in a local calling area (e.g., in a same area code or lower cost than a long distance number) to the first user (referred to as the “first pool number”). In other instances, the indication may indicate that the first user is or will be calling the second user using a previously assigned first pool number (stored at the first user device 108) that corresponds to the international number for the second user. Further still, the indication of the initiation of the call may be a call to the first pool number (e.g., if the first pool number was previously assigned), or an IP call to the service provider system 102.

If the indication of the initiation of the call includes the request for the first pool number, the communication module 302 may obtain the first pool number via the mapping module 304 and return the first pool number to any of one or more of the first user devices 106 of the first user 110 that are known to the service provider system 102 (e.g., registered with the service provider system 102). Further still, the first pool number may be returned to the communication application 112 on the user device 106 that sends the indication of the initiation of the call. In some embodiments, the first pool number may be returned using SMS, an audio call, or any other form of communication.

In some embodiments, the communication module 302 may also receive requests to pre-assign pool numbers to the first device 108 from the communication application 112. For example, when the first user 110 initially downloads or installs the communication application 112 on their user device 106, the communication application 112 may request that all international numbers in a contact list (e.g., address book) on the user device 106 be pre-assigned a pool number by sending such a request to the service provider system 102. Additionally, each time a new contact is added to the contact list or modified that is associated with an international number, the communication module 302 may receive a request from the communication application 112 to pre-assign a pool number to that international number.

The mapping module 304 manages the pool numbers at the service provider system 102. In example embodiments, the mapping module 304 determines a pool number to assign to a user that is local to the user. For example, the mapping module 304 may assign a pool number in the same area code as the user. If there is no pool number in the same area code, the mapping module 304 may assign a pool number that is the least expensive for the user to call. Once the pool number is assigned, the mapping module 304 may store the pool number along with related attributes. The related attributes may include one or more of a user identifier corresponding to the user (e.g., phone number of the first user device 106 of the first user 110), the corresponding international number, a time that the pool number was assigned, an expiration time for the pool number, a corresponding pool number assigned to the second user 114, and so forth. The related attributes may be used in comparing with a parameter of a call to a pool number in order to determine a proper connection to be made between two calls, as will be discussed in more detail below.

In an alternative embodiment, the mapping may be performed by the international dialer module 202. For example, the communication application 112 may obtain a plurality of available pool numbers via the communication module 302 and the mapping module 304. The international dialer module 202 maps a pool number to each international number in the contact list, and sends the mapping back to the service provider system 102. The communication module 302 receives the mapping and the mapping module 304 may store the mapping to the mapping data store 312.

The notification module 306 makes a notification call to the second user based on the indication that the first user is attempting to call the second user. In some embodiments, when the communication module 302 receives the indication of the call from the first user 110 to the second user 114, the notification module 306 makes an outbound notification call to the second user 114 (e.g., using the international number of the second user). For example, if the second user is registered with the service provider system 102, the notification module 306 may make a notification call to any one or more second user devices 108 that are known (e.g., registered) to the service provider system 102 even if the second user device 108 is at a different phone number than the phone number (e.g., international phone number) that the first user 110 is attempting to call. Alternatively, if the second user 114 is not known to the service provider system 102, the notification module 306 may make the notification call to the phone number that the first user 110 is attempting to call.

In one embodiment, when the second user 114 picks up the notification call, the notification module 306 connects the first user 110 to the second user 114. Once connected, the first user 110 has a limited amount of time (e.g., 30 seconds) in which to verbally communicate to the second user 114 to hang up the call and dial back the same number (e.g., the second pool number) from which the second user 114 received the notification call (e.g., based on caller ID). Alternatively, the first user 110 may verbally provide the second pool number to the second user 114. The second pool number may be a local number relative to the second user 114. After the limited amount of time has passed, the notification call is automatically disconnected if it has not already been manually disconnected.

In an alternative embodiment, when the second user 114 picks up the notification call, a recorded message is played indicating that it is a recorded message. The recorded message may inform the second user 114 that the first user 110 is waiting on a conference bridge for the second user 114. The second user 114 may further be told that if the second user 114 wants to talk to the first user 110, the second user 114 should hang up the notification call and immediately call back the same number (e.g., second pool number) from which the notification call is received. Alternatively, the recorded message may verbally provide the second pool number to the second user 114.

While example embodiments provide that a notification message is a notification call to the second user, alternatively the notification message may be may be a message sent via SMS or via the Internet. In another embodiment, the notification message may be sent to a communication application on one or more of the second user devices 108. Additionally, the notification message or notification call may be sent prior to the first user 110 initiating the call to the first pool number or after the first user 110 initiates the call to the first pool number.

In any of these embodiments, the second pool number may be obtained from the mapping module 304. The mapping module 304 may assign the second pool number in the same area code as the second user 114 or that is the least expensive (of available pool numbers) for the second user 114 to call. Once the second pool number is assigned, the mapping module 304 may store the second pool number along with related attributes (e.g., a user identifier corresponding to the second user 114, the corresponding international number, a time that the second pool number was assigned, an expiration time for the second pool number, user identifier of the first user 110, first pool number) in the mapping data store 312. In an alternative embodiment, a communication application at the second user device 108 may map the second pool number. For example, available pool numbers may be provided to the communication application. The communication application maps one of the pool numbers to a long distance or international number (e.g., the number of the first user that is attempting to call the second user), and sends the mapping back to the service provider system 102. The communication module 302 receives the mapping and the mapping module 304 may store the mapping to the mapping data store 312.

In some embodiments, the notification module 306 may send status to the first user 110 in response to an action performed by the second user 114. For example, status may be sent upon the second user 114 at the second user device 108 answering the notification call or the second call being initiated by the second user device 108. In one embodiment, the first user 110 may not place the first call to the first pool number until he has received status that the second user 114 has answered the notification call or has dialed the second pool number. In another embodiment, the first user device 106 may place the first call but the service provider system 102 may not pick up the first call. Instead, the service provider system 102 allows the first call to ring until, for example, the notification call has been made or received by the second user 114. This call sequence ensures that the second user device 108 is available before the first user device 106 calls the first pool number or before the first call is picked up by the service provider system 102.

The DTMF module 308 analyzes dual-tone multi-frequency signaling (DTMF) tones received with the first call or the second call to extract information. For example, the first call made by the first user device 106 to the first pool number may comprise DTMF tones that indicate a parameter, data, or code that maps the first call to the second call from the second user device 108 using the corresponding second pool number. For instance, the DTMF tone from the first call may indicate the user identifier of the second user 114 or the second pool number to which the first call should be connected.

The connection module 310 manages the connection of the calls received from the first user 110 and the second user 114, and determines whether to connect the calls or which calls are to be connected. In some embodiments, the connection module 310 may determine, receive, or extract at least one call parameter (also referred to as an “attribute”) associated with at least one of the first call or the second call. The call parameter is then used to map the first call to a second call from the second user 114. The call parameter may include, for example, the user identifier of the first user 110, the user identifier of the second user 114, the first pool number of the first call, or the second pool number of the second call that should be connected to the first call. Using at least one of these call parameters, the connection module 310 may access the mapping data store 312 to determine a mapping for the first call to the second call. For example, if the call parameter comprises the user identifier of the first user 110, the connection module 310 may determine, from the mapping data store 312, the second pool number that corresponds to the user identifier of the first user 110. Thus, when a second call via the second pool number is received by the connection module 310, the connection module 310 knows to connect these two calls. In alternative embodiments, the connection module 310 may be able to determine which calls to connect without having to access the mapping data store 312. Instead, the parameter obtained from the calls may be enough in themselves to indicate which calls to connect.

In some embodiments, the call parameters may be determined from DTMF tones received with the first call and/or the second call. In other embodiments, the call parameters may be determined from data received from the communication application (e.g., communication application 112). In some embodiments, the data from the communication application may be received separate from the first call or the second call. For example, the communication application 112 may call the first pool number while also sending data via SMS or over the Internet to the service provider system 102.

The mapping data store 312 may comprise a database of tables having tuples of attributes which indicate which pool number calls to connect. For example, a tuple may include the first pool number, the second pool number, the user identifier of the first user 110, and the user identifier of the second user 114. In another example, the tuple may include a user identifier of the first user 110, the second pool number, the user identifier of the second user 114, and an expiration time for the pool numbers. It is noted that each tuple may comprise any number of attributes and that the attributes may be any call parameter that is identifiable from the calls, data received from DTMF tones, or data received from the communication application 110. Additionally, because pool numbers are mapped to call parameters corresponding to the particular users or their user identifiers, the same pool number (e.g., the first pool number or the second pool number) may be assigned to different users.

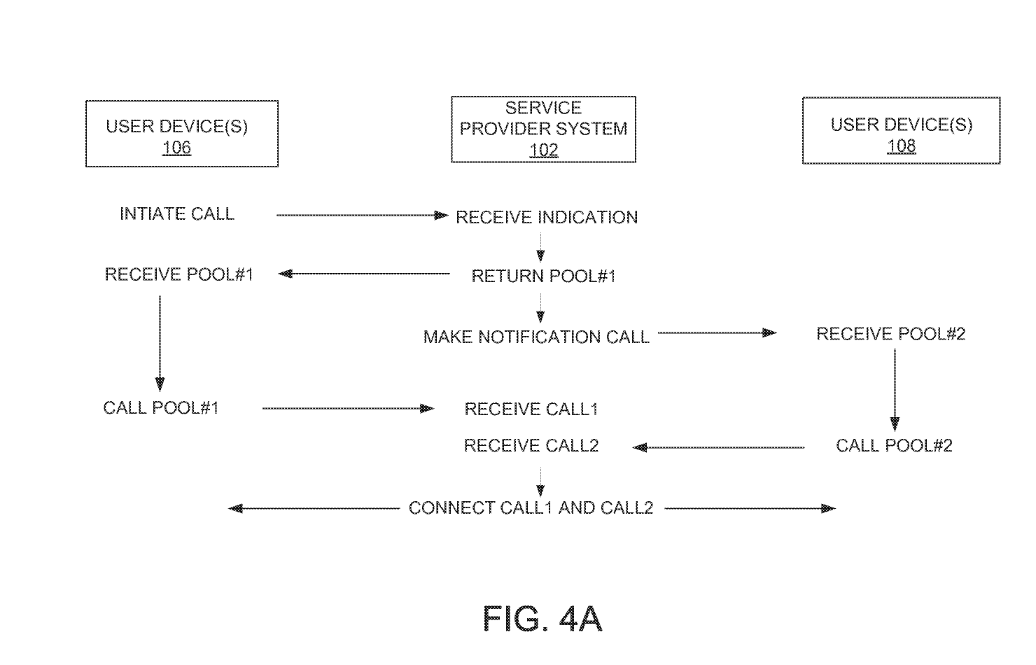

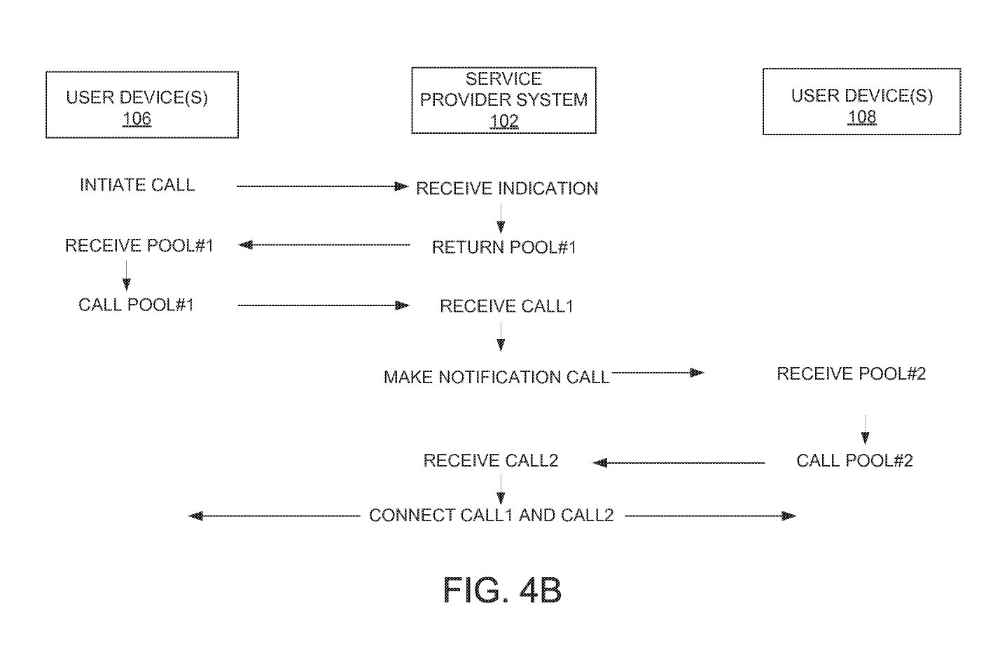

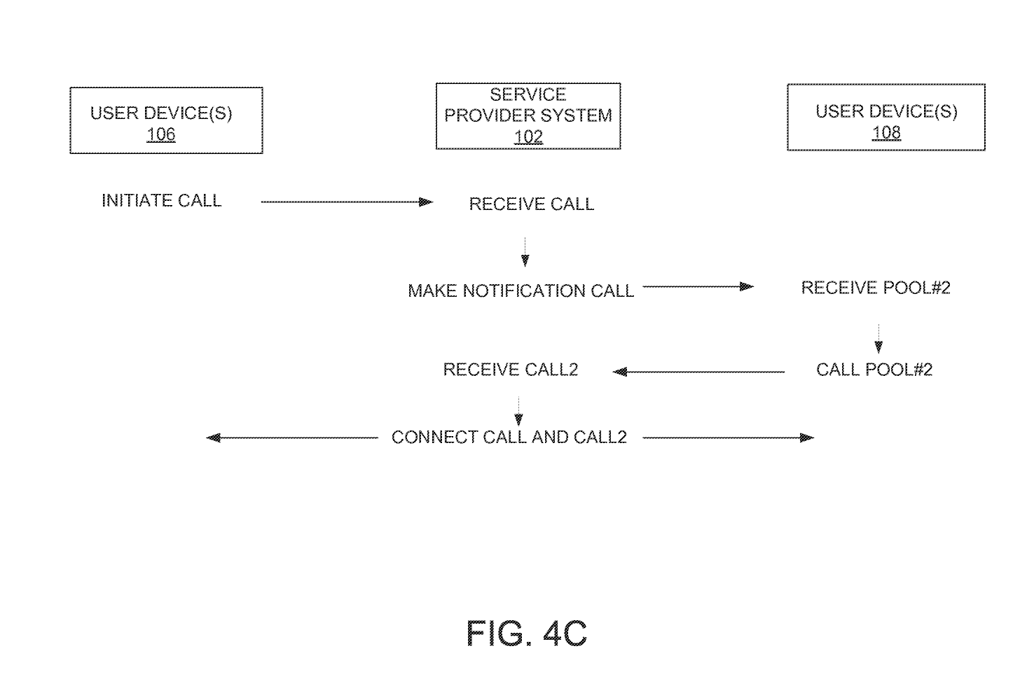

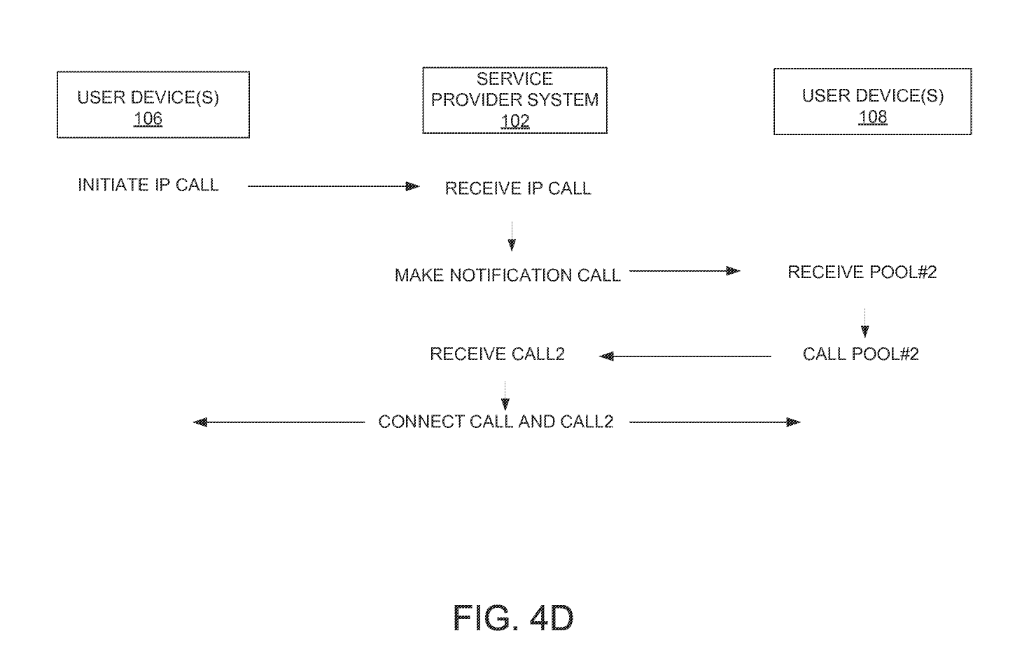

FIG. 4A is a communication flow diagram for international dialing through call connections according to one example embodiment. The embodiment of FIG. 4A assumes that the first user device 106 does not have a pre-assigned first pool number. Accordingly, a user at the first user device 106 (referred to as “user1”) initiates a call to the second user (referred to as “user2”). For example, user1 may dial an international number for user2 or select user2 from a contact list. An indication of the initiation of the call is received by the service provider system 102. The indication may be sent, for example by the communication application 112 and include a request for the first pool number.

In response, the service provider system 102 returns the first pool number (also referred to as “pool#1”) to the first user device 106 of user1. Additionally, the first pool number may be returned to any other user device that is registered with the service provider system 102 as belonging to user1. Substantially simultaneously with the receiving of the indication, the return of the first pool number, or both, the service provider system 102 makes a notification call to user2 at the second user device 108 (e.g., by using the international number for user2).

When user2 picks up the notification call, the service provider system 102 may either connect user1 to user2 or play a recorded audio message. If user1 is connected to user2, user1 is given a limited amount of time (e.g., 30 seconds) to inform user2 to hang up and call a second pool number. Alternatively, the recorded audio message may instruct user2 to hang up and call the second pool number (e.g., the number that is making the notification call or a second pool number audibly provided). As such, the notification call provides the second pool number (also referred to as “pool#2) to user2.

While the notification call was being made to user2 at the second user device 108 (or after the notification call is made), the first user device 106 of user1 may call pool#1. The service provider system 102 receives both call1 via pool#1 and call2 via pool#2. The service provider system 102 makes a determination to connect call1 and call2 (e.g., based on at least one call parameter) and connects call1 and call2.

FIG. 4B is a communication flow diagram for international dialing through call connections according to another example embodiment. The embodiment of FIG. 4B also assumes that the first user device 106 does not have a pre-assigned first pool number for calling the second user. Accordingly, user1 at the first user device 106 initiates a call to user2. For example, user1 may dial an international number for user2 or select user2 from a contact list. An indication of the initiation of the call is received by the service provider system 102. The indication may be sent, for example by the communication application 112 and include a request for the first pool number.

In response, the service provider system 102 returns pool#1 to user1. However, unlike the embodiment of FIG. 4A, the service provider system 102 does not make the notification call to user2 until the service provider system receives call 1 via pool#1 from user1. The service provider system 102 may answer call1 and place user1 on hold or allow call1 to continue ringing until user2 calls in. Once call1 is received, the service provider system 102 makes the notification call to user2 at the second user device 108. The notification call may provide a recorded audio message that instructs user2 to hang up and call a second pool number (e.g., the number that is making the notification call or a second pool number audibly provided). Alternatively, user1 is given a limited amount of time (e.g., 30 seconds) to inform user2 to hang up and call a second pool number. As such, the notification call provides pool#2 to user2. The service provider system 102 then receives call2 via pool#2. The service provider system 102 makes a determination to connect call and call2 (e.g., based on at least one call parameter), and connects call 1 and call2.

FIG. 4C is a communication flow diagram for international dialing through call connections according to another example embodiment. The embodiment of FIG. 4C assumes that the first user device 106 has a pre-assigned first pool number for calling user2. For example, when user1 initially downloaded or installed the communication application 112 on their user device 106, all international or long distance numbers in a contact list (e.g., address book) on the first user device 106 may be pre-assigned a pool number. Additionally, each time a new contact is added to the contact list or modified that is associated with an international number, a pool number may be assigned to that international number.

Accordingly, user1 initiates a call to user2 by either dialing the international number of user2 and having the communication application 110 on the first user device 106 intercept and dial pool#1, or selecting a contact entry in a contact list for user2 that automatically dials pool#1. As such, the indication of initiation of the call is, in this case, the call (e.g., call 1), itself. The call may be a PSTN call or an IP call. The service provider system 102 receives call1, and may either answer call1 and place user1 on hold or allow call1 to continue ringing until user2 calls in. In response, the service provider system 102 makes a notification call to user2 at the second user device 108. The notification call may provide a recorded audio message that instructs user2 to hang up and call a second pool number (e.g., the number that is making the notification call or a second pool number audibly provided). Alternatively, user1 is given a limited amount of time (e.g., 30 seconds) to inform user2 to hang up and call a second pool number. As such, the notification call provides pool#2 to user2. The service provider system 102 receives call2 via pool#2 and makes a determination to connect call1 and call2 (e.g., based on at least one call parameter), and connects call and call2.

FIG. 4D is a communication flow diagram for international dialing through call connections according to another example embodiment. The embodiment of FIG. 4D assumes the first user device 106 makes the first call as an IP call. Accordingly, user1 initiates an IP call to user2 by either dialing the international number of user2 and having the communication application 110 on the first user device 106 intercept and make the IP call, or selecting a contact entry in a contact list for user2 that automatically initiates the IP call. As such, the indication of initiation of the call is, in this case, the IP call (e.g., call 1), itself. Alternatively, the first user device 106 may have previously sent the indication of the initiation of the call which indicated that user1 will be requesting a call to user2. The service provider system 102 receives the IP call, and may either answer the IP call and place user1 on hold or allow the IP call to continue ringing until user2 calls in.

In response to receiving the IP call, the service provider system 102 makes a notification call to user2 at the second user device 108. User2 may be determined based on a call parameter of the IP call (e.g., user identifier of the first user 110). The notification call may provide a recorded audio message that instructs user2 to hang up and call a second pool number (e.g., the number that is making the notification call or a second pool number audibly provided). Alternatively, user1 is given a limited amount of time (e.g., 30 seconds) to inform user2 to hang up and call a second pool number. As such, the notification call provides pool#2 to user2. The service provider system 102 receives call2 via pool#2 and makes a determination to connect call1 and call2 (e.g., based on at least one call parameter), and connects call and call2.

While various embodiments have been described in FIG. 4A-FIG. 4D, these embodiments are merely examples and embodiments of the present invention are not limited to just these. The operations of providing pool#1, providing pool#2, or making a notification call may be performed in different orders along with the making/receiving of calls using pool#1 and pool#2 occurring at different times during the communication flow. According the various operations of the example embodiments may be practiced in different orders so long as a notification call is made to the second user, pool numbers are provided to respective user devices, calls are received from each user to their respective pool numbers.

Additionally, the pool number may be received on one user device of the user and used to make the call on a different user device of the user or using a different network type. For example, the notification call may be made to the international number of the second user and received on a cellular phone of the second user. However, the second user may decide to call the second pool number provided by the notification call using their landline phone.

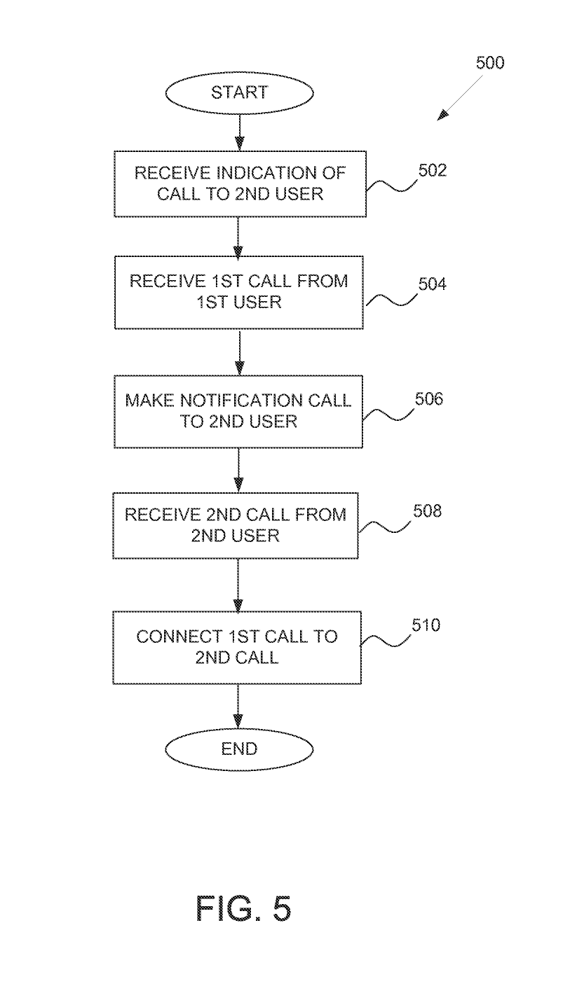

FIG. 5 is a flow diagram of an example method 500 for providing international dialing through call connections. The operations of the method 500 may occur at the service provider system 102. Accordingly, the first user 110 at the first user device 106 initiates a call to the second user 114. For example, the first user 110 may dial an international number for the second user 114 or select the second user 114 from a contact list. An indication of the initiation of the call is received by the service provider system 102 in operation 502 (e.g., by the communication module 302). The indication may be sent, for example by the communication application 112. In some embodiments, the indication may include a request for a first pool number.

If the indication includes a request for the first pool number, the service provider system 102 returns the first pool number to the first user 110. In example embodiments, the mapping module 304 determines the first pool number to assign to the first user 110. For example, the mapping module 304 may assign the first pool number in the same area code as the first user 110. Once the first pool number is assigned, the mapping module 304 may store the pool number along with related attributes (e.g., user identifier corresponding to the user, the corresponding international number, a time that the pool number was assigned, an expiration time for the pool number). The first pool number may then be provided via the communication module 302 to any of one or more user devices associated with the first user 110.

In operation 504, the communication module 302 receives the first call (e.g., via PSTN to the first pool number or via an IP call to the server provider system 102) from the first user 110. While the receipt of the first call is shown in FIG. 5 to occur prior to operation 506, in some embodiments, the first call may be received after operation 506. Further still, the first call may, in alternative embodiments, be the indication of the call to the second user (operation 502) or be sent substantially simultaneously with the indication of the call. These alternative embodiments may occur when the first user 110 has the first pool number prior to initiating the call to the second user 114 in operation 502. Additionally, the first user 110 may call the first pool number using any user device associated with the first user 110, and is not limited to calling the first pool number using the user device 106 that has the communication application 112.

In operation 506, the notification module 306 makes a notification call to the second user 114 at the second user device 108. In one embodiment, when the second user 114 picks up the notification call, the notification module 306 connects the first user 110 to the second user 114. Once connected, the first user 110 has a limited amount of time (e.g., 30 seconds) in which to verbally communicate to the second user 114 to hang up the call and dial back the same number (e.g., the second pool number) from which the second user 114 received the notification call (e.g., based on caller ID). Alternatively, the first user 110 may verbally provide the second pool number to the second user 114.

In an alternative embodiment, when the second user 114 picks up the notification call, a recorded message is played indicating that it is a recorded message. The recorded message may inform the second user 114 that the first user 110 wants to talk to the second user and that if the second user 114 wants to talk to the first user 110, the second user 114 should hang up the notification call and immediately call back the same number (e.g., second pool number) from which the notification call is received. Alternatively, the recorded message may verbally provide the second pool number to the second user 114.

In operation 508, the communication module 302 receives the second call from via the second pool number from the second user 114. The second user 114 may call the second pool number using any user device and using any type of network, and is not limited to call the second pool number using the same user device that received the second pool number. In an embodiment where the second user device 108 has a communication application, the communication application on the second user device 108 may receive the notification call (e.g., from the second pool number) and automatically make the second call to the second pool number. In this embodiment, the second user device 108 does not even need to answer the notification call.

In operation 510, the first call and the second call are connected based on a determination that these calls are to be connected. In example embodiments, the connection module 310 manages the connection of calls received via pool numbers and determines whether to connect the calls. In some embodiments, the connection module 310 may determine, receive, or extract at least one call parameter associated with at least one of the first call or the second call. The call parameter is then used to map the first call to a second call from the second user 114. The call parameter may include, for example, the user identifier of the first user 110, the user identifier of the second user 114, the first pool number of the first call, and the second pool number of the second call. Using at least one of these call parameters, the connection module 310 may access the mapping data store 312 to determine a mapping for the first call to the second call. In some embodiments, the call parameters may be determined from DTMF tones received with the first call and/or the second call. In other embodiments, the call parameters may be determined from data received from the communication application (e.g., communication application 112).

As discussed with respect to the example embodiments of FIG. 4A-FIG. 4C, the operations of the method 500 may be performed in a different order. For example, the first pool number may be pre-assigned before the receiving of the indication of the call to the second user 114 (operation 502). Additionally, the second pool number may be provided before the notification call (operation 506). In this embodiment, the notification call may, for example, inform the second user 114 to call the previously assigned second pool number to connect with the first user 110. Furthermore, the second call via the second pool number (operation 508) may be received before the first call via the first pool number (operation 504) is placed.

FIG. 6 is a block diagram illustrating components of a machine 600, according to some example embodiments, able to read instructions from a machine-readable medium (e.g., a non-transitory machine-readable medium, a machine-readable storage medium, a computer-readable storage medium, or any suitable combination thereof) and perform any one or more of the methodologies discussed herein. Specifically, FIG. 6 shows a diagrammatic representation of the machine 600 in the example form of a computer system and within which instructions 624 (e.g., software, a program, an application, an applet, an app, or other executable code) for causing the machine 600 to perform any one or more of the methodologies discussed herein may be executed.

In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network muter, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alpha-numeric input device 612 (e.g., a keyboard or keypad), a cursor control device 614 (e.g., a mouse, a touchpad, a trackball, a joystick, a motion sensor, or other pointing instrument), a storage unit 616, a signal generation device 618 (e.g., a sound card, an amplifier, a speaker, a headphone jack, or any suitable combination thereof), and a network interface device 620.

The storage unit 616 includes a machine-readable medium 622 (e.g., a tangible and/or non-transitory machine-readable storage medium) on which is stored the instructions 624 embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media (e.g., tangible and/or non-transitory machine-readable media). The instructions 624 may be transmitted or received over a network 626 via the network interface device 620. For example, the network interface device 620 may communicate the instructions 624 using any one or more transfer protocols (e.g., hypertext transfer protocol (HTTP)).

In some example embodiments, the machine 600 may be a portable computing device, such as a smart phone or tablet computer, and have one or more additional input components (e.g., sensors or gauges). Examples of such additional input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a tangible machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 600), such that the instructions, when executed by one or more processors of the machine (e.g., processor 602), cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data tangible (e.g., non-transitory) data repositories in the form of a solid-state memory, an optical medium, a magnetic medium, or any suitable combination thereof.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 624 may further be transmitted or received over a communications network 626 using a transmission medium via the network interface device 620 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving an indication of an initiation of a call by a first user to a second user;
in response to the receiving of the indication, making a notification call to the second user, the notification call providing a second pool number to the second user, the second pool number being different from a phone number of the first user;
receiving a first call from the first user;
receiving a second call from the second user via the second pool number; and
connecting, using a hardware processor, the first call and the second call.

2. The method of claim 1, wherein the first call is to a first pool number, the first pool number being different from a phone number of the second user.

3. The method of claim 1, wherein the receiving the indication of the initiation of the call attempt comprises the receiving of the first call from the first user at the server.

4. The method of claim 1, wherein the receiving the indication of the initiation of the call comprises receiving the indication from a communication application installed on a device of the first user.

5. The method of claim 1, further comprising causing the notification call to be automatically terminated after a predetermined period of time.

6. The method of claim 1, wherein the providing the second pool number comprises making the notification call to the second user from the second pool number.

7. The method of claim 1, wherein the providing the second pool number comprises a selection from the group consisting of providing a recorded audio message and providing a live audio message by the first user.

8. The method of claim 1, wherein the second call from the second user to the second pool number is caused to be performed automatically without any action by the second user in response to the notification call.

9. The method of claim 1, further comprising determining, based on a call parameter, that the first call from the first user and the second call from the second user are to be connected.

10. The method of claim 9, further comprising determining the call parameter based on dual-tone multi-frequency signaling (DTMF) tones received from at least one of the first call or the second call, the DTMF tones providing data that maps the first call to the second call.

11. The method of claim 9, further comprising determining the call parameter based on data received from a communication application of a device of at least one of the first user or the second user, the data from the communication application used to map the first call to the second call

12. The method of claim 9, further comprising mapping a first identifier of the first user to at least one of a second identifier of the second user or the second pool number, wherein the call parameter comprises the first identifier of the first user received with the first call and at least one of the second identifier of the second user received with the second call or the second pool number of the second call.

13. The method of claim 9, further comprising mapping a second identifier of the second user to at least one of a first identifier of the first user or a first pool number used by the first user to make the first call, wherein the call parameter comprises the second identifier of the second user received with the second call and at least one of the first identifier of the first user received with the first call or the first pool number of the first call.

14. The method of claim 1, further comprising assigning at least one of a first pool number used by the first user to make the first call or the second pool number used by the second user to make the second call to a plurality of other users.

15. The method of claim 1, wherein the initiation of the call comprises a selection from the group consisting of: the first user initiating the call to the phone number of the second user, the first user selecting to call the second user from a contact list, a communication application on the device of the first user receiving a first pool number that is used to make the first call, the first user initiating an IP call to service provider system, and the communication application on the device of the first user initiating the call to the first pool number instead of the phone number of the second user.

16. The method of claim 1, wherein a the first user uses a first pool number to make the first call, the first pool number is located in a first calling area that has a low cost for the first user and the second number is located in a second calling area that has a low cost for the second user.

17. The method of claim 1, wherein the first call is an Internet Protocol (IP) call to a service provider system.

18. A machine-readable medium having no transitory signals and storing instructions which, when executed by the at least one processor of a machine, cause the machine to perform operations comprising:
receiving an indication of an initiation of a call by a first user to a second user;
in response to the receiving of the indication, making a notification call to the second user, the notification call providing a second pool number to the second user, the second pool number being different from a phone number of the first user;
receiving a first call from the first user;
receiving a second call from the second user via the second pool number; and
connecting the first call and the second call.

19. A system comprising:
a hardware processor;
a communication module configured to receive an indication of an initiation of a call by a first user to a second user;
a notification module configured to make a notification call to the second user in response to the received indication, the notification call providing a second pool number to the second user, the second pool number being different from a phone number of the first user;
the communication module configured to receive a first call from the first user and a second call from the second user via the second pool number, and
a connection module configured to connect, using the hardware processor, the first call and the second call.

20. The system of claim 19, further comprising a mapping module to assign a first pool number to the first user that is used to make the first call, the first pool number being different from a phone number of the second user and to assign the second pool number to the second user, the second pool number being different from a phone number of the first user.
